(19) United States
(12) Patent Application Publication
(10) Pub. No.: US 2020/0223478 A1
(43) Pub. Date: Jul. 16, 2020

(54) STEERING DEVICE AND VEHICLE WHEEL MOUNTING MODULE INCLUDING THE SAME

(71) Applicant: TOYOTA JIDOSHA KABUSHIKI KAISHA, Toyota-shi (JP)

(72) Inventor: Katsuyuki SANO, Miyoshi-shi (JP)

(73) Assignee: TOYOTA JIDOSHA KABUSHIKI KAISHA, Toyota-shi (JP)

(21) Appl. No.: 16/722,149

(22) Filed: Dec. 20, 2019

(30) Foreign Application Priority Data
Jan. 16, 2019 (JP) 2019-004985

(51) Int. Cl. B62D 7/18; B62D 7/16; B62D 5/04; B60G 7/00; B60G 15/06; B60K 7/00

(52) U.S. Cl. CPC B62D 7/18; B62D 7/166; B62D 5/0418; B60G 7/001; B60K 2007/0092; B60K 7/0007; B60G 2202/312; B60G 2202/12; B60G 2202/20; B60G 15/062

(57) ABSTRACT

A steering device, including: a steering knuckle rotatably holding a wheel and pivotally supported by a suspension arm through a first joint; a steering actuator disposed on the suspension arm; and a tie rod a proximal end portion of which is coupled to the steering actuator and a distal end portion of which is coupled to the steering knuckle through a second joint.

### CROSS REFERENCE TO RELATED APPLICATION

The present application claims priority from Japanese Patent Application No. 2019-004985, which was filed on Jan. 16, 2019, the disclosure of which is herein incorporated by reference in its entirety.

### BACKGROUND

### Technical Field

The following disclosure relates to a steering device configured to steer a wheel and a vehicle wheel mounting module which includes the steering device as a constituent element and through which the wheel is mounted on a vehicle.

### Description of Related Art

A steering device configured to steer only one of a plurality of wheels of a vehicle, namely, a steering device configured to steer only one of right and left wheels, may be referred to as a single-wheel steering device. For instance, Patent Document 1 (Japanese Patent Application Publication No. 2007-1564) discloses a steering device as the single-wheel steering device.

### SUMMARY

A steering actuator of the steering device disclosed in Patent Document 1 is provided on a body of a vehicle. In the case where a suspension device, a wheel driving and rotating device, and the steering device are modularized, that is, those devices are formed as one module, i.e, a wheel mounting module, the steering device and the module lack utility. That is, a mounting work of mounting such a module on the vehicle is inevitably cumbersome. Accordingly, one aspect of the present disclosure is directed to a steering device having high utility. Another aspect of the present disclosure is directed to a vehicle wheel mounting module having high utility owing to employment of the steering device.

In one aspect of the present disclosure, a steering device includes:

a steering knuckle rotatably holding a wheel and pivotally supported by a suspension aim through a first joint;

a steering actuator disposed on the suspension arm; and

a tie rod a proximal end portion of which is coupled to the steering actuator and a distal end portion of which is coupled to the steering knuckle through a second joint.

In another aspect of the present disclosure, a wheel mounting module for a vehicle including the steering device constructed as described above further includes:

the suspension arm;

a wheel drive unit which is disposed inside a rim of the wheel, a housing of which functions as the steering knuckle, and which includes a drive motor for driving the wheel; and

a suspension spring and a shock absorber disposed between the suspension arm and a body of the vehicle so as to be in parallel with each other.

The steering device of the present disclosure is the single-wheel steering device and is configured such that the steering actuator is provided on the suspension arm of a suspension device provided for one wheel. The wheel mounting module is constructed so as to incorporate the thus configured steering device, so that the work of mounting the module onto the vehicle body can be facilitated. That is, the present disclosure enables construction of the wheel mounting module excellent in mountability on the vehicle, and the steering device of the present disclosure is accordingly excellent in utility. Further, the wheel mounting module of the present disclosure that employs the steering device of the present disclosure is a practical wheel mounting module excellent in mountability on the vehicle.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a perspective view of a steering device according to one embodiment and a vehicle wheel mounting module including the steering device;

FIG. 2A is a view illustrating a conventional steering device and a positional relationship between a first joint and a second joint in the steering device;

FIG. 2B is a view illustrating a single-wheel steering device designed based on the steering device of FIG. 2A and a positional relationship between a first joint and a second joint in the single-wheel steering device;

FIG. 3A is a perspective view of the steering device according to the embodiment; and

FIG. 3B is a view illustrating a positional relationship between a first joint and a second joint in the steering device of FIG. 3A.

### VARIOUS FORMS OF STEERING DEVICE AND VEHICLE WHEEL MOUNTING MODULE ACCORDING TO PRESENT DISCLOSURE

The type of the suspension device to which is applied the steering device of the present disclosure is not limited to a particular one. The present steering device is applicable to various types of suspension device such as a MacPherson type suspension device and a double wishbone type suspension device. In the case where the present steering device is applied to the MacPherson type suspension device, the steering actuator is provided on a lower arm as the suspension arm. In the case where the present steering device is applied to the double wishbone type suspension device, the steering actuator is provided on any one of a lower arm and an upper arm each as the suspension arm. A ball joint is employable as each of the first joint and the second joint. The steering actuator is configured to move the tie rod generally in its axial direction. For instance, the steering actuator may be configured to pivot what is called pitman arm which extends in a direction intersecting the tie rod and to which a proximal end portion of the tie rod is coupled. The steering actuator may include an electric motor as a drive source and a speed reducer configured to decelerate rotation of the electric motor. A distal end portion of the tie rod is coupled to a knuckle arm of the steering knuckle, for instance.

The structure of the steering actuator is not limited to a particular one. In the case where the steering actuator includes an electric motor as a drive source, it is desirable that the steering actuator be disposed near a proximal end portion of the suspension arm in consideration of the inertial force that acts on the steering actuator, the unsprung weight, and a wiring layout for supplying a power to the electric motor. Specifically, the steering actuator is desirably disposed at a position nearer to the pivot axis of the suspension arm than an intermediate point between the pivot axis of the suspension arm and the center of the first joint.

There will be next explained a positional relationship between the first joint and the second joint. The center of the second joint is preferably located on a plane defined by the pivot axis of the suspension arm and the center of the first joint. This plane will be hereinafter referred to as “arm reference plane” where appropriate. As will be later explained in detail, the center of the second joint is located on the arm reference plane, so that a change in a steering angle caused by a bound/rebound movement of the wheel can be reduced or prevented. The steering angle is also referred to as a toe angle. Here, the concept that “the center of the second joint is located on the arm reference plane” includes a concept that the center of the second joint is substantially located on the arm reference plane.

The wheel mounting module of the present disclosure enables the wheel to be held by the vehicle body and enables a plurality of necessary functions in relation to the wheel to be attained in one unit, the functions including a wheel driving and rotating function, a wheel steering function, and a vehicle body suspension function. That is, the wheel driving and rotating device, the wheel steering device, and the suspension device are modularized as one package. The wheel mounting module of the present disclosure is preferably constructed such that a brake device is also incorporated into the module for attaining a wheel braking function. Specifically, the brake device may be configured to include a disc rotor that rotates with the wheel and a brake caliper held by the housing of the wheel drive unit to stop rotation of the wheel by stopping rotation of the disc rotor.

### DETAILED DESCRIPTION OF THE EMBODIMENT

Referring to the drawings, there will be explained below in detail a steering device according to one embodiment of the present disclosure and a vehicle wheel mounting module according to one embodiment of the present disclosure including the steering device. It is to be understood that the present disclosure is not limited to the details of the following embodiment but may be embodied based on the forms described in Various Forms and may be changed and modified based on the knowledge of those skilled in the art.

### A. Overall Structure of Vehicle Wheel Mounting Module

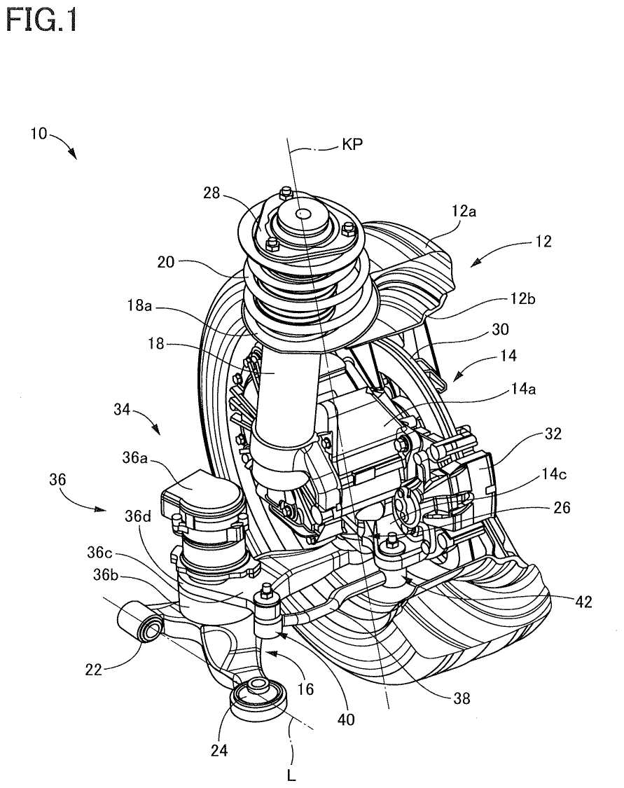

FIG. 1 shows a vehicle wheel mounting module 10 (hereinafter simply referred to as “module 10” where appropriate) according to one embodiment. The module 10 is for mounting, on a body of a vehicle, a wheel 12b on which a tire 12a is mounted. Though the wheel 12b itself may be regarded as a wheel, the wheel 12b on which the tire 12a is mounted is referred to as a wheel 12 in the present embodiment for convenience sake.

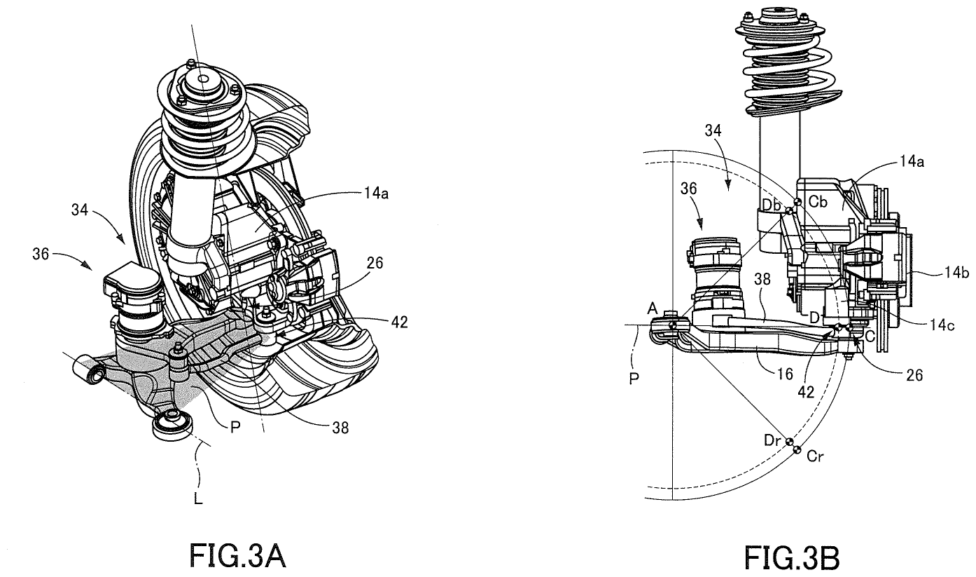

The module 10 includes a wheel drive unit 14 as a wheel driving and rotating device. The wheel drive unit 14 includes: a housing 14a; an electric motor as a drive source and a reducer configured to reduce rotation of the electric motor (both of which are housed in the housing 14a and are not shown in FIG. 1); and an axle hub 14b (FIG. 3B) to which the wheel 12b is attached. (The axle hub is hidden in FIG. 1.) The wheel drive unit 14 is disposed inside a rim of the wheel 12b. The wheel drive unit 14 is what is called in-wheel motor unit. The wheel drive unit 14 is well known, and its explanation is dispensed with.

The module 10 includes a MacPherson type suspension device (also referred to as a MacPherson strut type suspension device). In the suspension device, the housing 14a of the wheel drive unit 14 functions as a carrier rotatably holding the wheel, in other words, the housing 14a functions as a steering knuckle of a steering device that will be explained. Accordingly, the suspension device is constituted by a lower arm 16 as a suspension arm, the housing 14a of the wheel drive unit 14, a shock absorber 18, and a suspension spring 20.

The suspension device has an ordinary structure and will be briefly explained. The lower arm 16 is an L-shaped arm. A proximal end portion of the lower arm 16 is divided into two portions arranged in the front-rear direction of the vehicle. The lower arm 16 is supported by a side member (not shown) of the vehicle body through a first bushing 22 and a second bushing 24 so as to be pivotable at the proximal end portion about an arm pivot axis L. A distal end portion of the lower arm 16 is pivotally coupled to a lower portion of the housing 14a of the wheel drive unit 14 through a ball joint 26 for use in coupling the lower arm 16. The ball joint 26 is one example of a first joint and will be hereinafter referred to as “first joint 26”.

The shock absorber 18 is securely supported at a lower end thereof to the housing 14a of the wheel drive unit 14 and is supported at an upper end thereof by an upper portion of a tire housing of the vehicle body through an upper support 28. The suspension spring 20 is supported at an upper end thereof by the upper portion of the tire housing of the vehicle body through the upper support 28 and is supported at a lower end thereof by a lower support 18a in the form of a flange provided on the shock absorber 18. That is, the suspension spring 20 and the shock absorber 18 are disposed between the lower arm 16 and the vehicle body so as to be in parallel with each other.

The module 10 includes a brake device. The brake device includes: a disc rotor 30 attached to the axle hub 14b together with the wheel 12b and configured to rotate with the wheel 12; and a brake caliper 32 held by the housing 14a of the wheel drive unit 14 such that the brake caliper 32 straddles the disc rotor 30. Though not explained in detail, the brake caliper 32 includes: brake pads each as a friction member; and a brake actuator including an electric motor and configured to stop rotation of the wheel 12 by pushing the brake pads onto the disc rotor 30 by the force of the electric motor. The brake device is an electric brake device configured to generate a braking force in dependence on the force generated by the electric motor.

The module 10 includes a steering device 34 according to one embodiment of the present disclosure. The steering device 34 is a single-wheel steering device for steering only one of right and left wheels 12. The steering device 34 includes the housing 14a of the wheel drive unit 14 functioning as the steering knuckle, a steering actuator 36 provided on the lower arm 16 at a position near the proximal end portion of the lower arm 16, and a tie rod 38 coupling the steering actuator 36 and the steering knuckle 14a. The housing 14a of the wheel drive unit 14 will be referred to as “steering knuckle 14a” when treated as a constituent element of the steering device 34.

The steering actuator 36 includes a steering motor 36a that is an electric motor as a drive source, a speed reducer 36b for decelerating rotation of the steering motor 36a, and a rotating plate 36d including an actuator arm 36c that functions as a pitman arm and configured to be driven and rotated by the rotation of the steering motor 36a decelerated by the speed reducer 36b. A proximal end portion of the tie rod 38 is coupled to the actuator arm 36c through a ball joint 40 for use in coupling the proximal end portion of the tie rod 38. A distal end portion of the tie rod 38 is coupled to a knuckle arm 14c of the steering knuckle 14a through a ball joint 42 for use in coupling the distal end portion of the tie rod 38. The ball joint 42 is one example of a second joint and will be hereinafter referred to as “second joint 42”.

The suspension device is the MacPherson type suspension device. A line connecting the center of the upper support 28 and the center of the first joint 26 is a kingpin axis KP. By controlling an operation of the steering motor 36a, the steering knuckle 14a is pivoted by the steering actuator 36 about the kingpin axis KP. That is, the wheel 12 is steered.

The steering device 34 is configured such that the steering actuator 36 is provided on the lower arm 16. Thus, a work of mounting the module 10 on the vehicle body can be easily performed. In short, the proximal end portion of the lower arm 16 is attached to the side member of the vehicle body, and the upper support 28 is attached to the upper portion of the tire housing of the vehicle body, whereby the module 10 can be mounted on the vehicle. That is, the module 10 is excellent in mountability on the vehicle.

B. Positional Relationship between First Joint and Second Joint

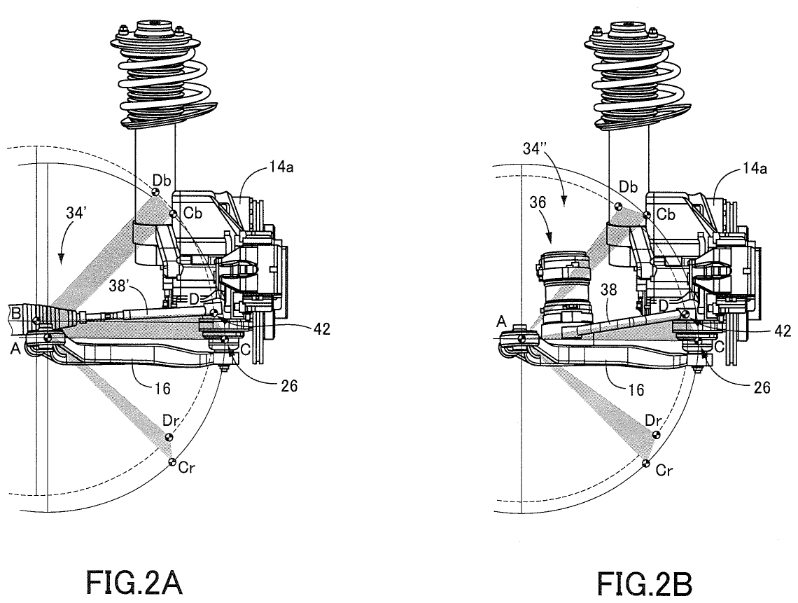

There will be considered a positional relationship between the first joint 26 and the second joint 42. FIG. 2A illustrates an ordinary steering device 34′ configured to steer right and left wheels together. The steering device 34′ includes a steering rod that extends rightward and leftward at a widthwise middle position of the vehicle body. A tie rod 38′ is coupled to each of opposite ends of the steering rod. FIG. 2A is a view of the steering device 34′ seen from the rear side of the vehicle. In FIG. 2A, a point A indicates a position on which is located the arm pivot axis L that is a pivot axis of the lower arm 16, and a point B indicates a center of a coupled portion of the steering rod and the tie rod 38′. Similarly, a point C indicates a center position of the first joint 26, and a point D indicates a center position of the second joint 42.

When the wheel bounds and rebounds, the lower arm 16 pivots about the point A, and the first joint 26 moves on an arc whose center lies on the point A while the second joint 42 moves on an arc whose center lies on the point B. When the wheel bounds extremely, the center of the first joint 26 is located on a point Cb and the center of the second joint 42 is located on a point Db. On the other hand, when the wheel rebounds extremely, the center of the first joint 26 is located on a point Cr and the center of the second joint 42 is located on a point Dr.

The bound/rebound movement of the wheel causes the steering knuckle 14a to move upward and downward without substantially changing its posture, that is, without substantially involving rotational displacement. Specifically, the steering knuckle 14a does not substantially incline along a plane perpendicular to the arm pivot axis when the steering knuckle 14a moves upward and downward. Thus, the upward and downward movement of the steering knuckle 14a causes a change in a distance between the point C and the point D in the vehicle width direction, whereby the steering knuckle 14a pivots about the kingpin axis KP and the wheel is accordingly steered. In other words, the bound/rebound movement of the wheel causes a change in the toe angle of the wheel.

Considering from a different viewpoint, it can be said that there is constituted, in the ordinary steering device 34′ illustrated in FIG. 2A, a four link mechanism whose four link points respectively correspond to the point A, the point B, the point C, and the point D, thus resulting in a relatively small change in the vehicle widthwise distance between the point C and the point D caused by the bound/rebound movement of the wheel. Accordingly, the change in the toe angle of the wheel caused by the bound/rebound movement is relatively small.

A case is considered in which there is constructed a single-wheel steering device having the steering actuator 36 provided on the lower arm 16 while maintaining the positional relationship between the first joint 26 and the second joint 42 in the ordinary steering device 34′. This steering device is a steering device 34″ illustrated in FIG. 2B. In the steering device 34″, when the wheel bounds and rebounds, both the first joint 26 and the second joint 42 pivot about the point A, namely, the arm pivot axis L. In FIG. 2B, a point Cb indicates the center of the first joint 26 and a point Db indicates the center of the second joint 42 when the wheel bounds extremely. Further, a point Cr indicates the center of the first joint 26 and a point Dr indicates a center of the second joint 42 when the wheel rebounds extremely. As apparent from those points Cb, Db, Cr, Dr, the steering device 34″ illustrated in FIG. 2B suffers from a relatively large change in the vehicle widthwise distance between the point C and the point D caused by the bound/rebound movement of the wheel. Accordingly, the toe angle of the wheel changes relatively largely due to the bound/rebound movement of the wheel.

FIG. 3A is a perspective view of the steering device 34 according to the present embodiment, and FIG. 3B is a view of the steering device 34 seen from the rear side of the vehicle. To reduce or prevent the change in the toe angle of the wheel described above, the steering device 34 is constructed such that the center of the second joint 42 is located on a plane P defined by the arm pivot axis L and the center of the first joint 26. The plane P will be hereinafter referred to as “arm reference plane P” where appropriate. Specifically, the distal end portion of the knuckle arm 14c is located at a height level lower than that in the steering device 34″ illustrated in FIG. 2B.

FIG. 3B shows a positional change of each of the point C and the point D. In FIG. 3B, a point Cb indicates the center of the first joint 26 and a point Db indicates the center of the second joint 42 when the wheel bounds extremely. Further, a point Cr indicates the center of the first joint 26 and a point Dr indicates a center of the second joint 42 when the wheel rebounds extremely. As apparent from those points Cb, Db, Cr, Dr, the change in the vehicle widthwise distance between the point C and the point D caused by the bound/rebound movement of the wheel is considerably small in the steering device 34 of the present embodiment. Thus, the change in the toe angle of the wheel caused by the bound/rebound movement of the wheel is considerably small.

What is claimed is:

1. A steering device, comprising:
a steering knuckle rotatably holding a wheel and pivotally supported by a suspension arm through a first joint;
a steering actuator disposed on the suspension arm; and
a tie rod a proximal end portion of which is coupled to the steering actuator and a distal end portion of which is coupled to the steering knuckle through a second joint.

2. The steering device according to claim 1, wherein a center of the second joint is located on a plane defined by a pivot axis of the suspension arm and a center of the first joint.

3. The steering device according to claim 1, which is mounted on a MacPherson type suspension device having a lower arm as the suspension arm.

4. A wheel mounting module for a vehicle, comprising the steering device according to claim 1, further comprising:
the suspension arm;
a wheel drive unit which is disposed inside a rim of the wheel, a housing of which functions as the steering knuckle, and which includes a drive motor for driving the wheel; and
a suspension spring and a shock absorber disposed between the suspension arm and a body of the vehicle so as to be in parallel with each other.

5. The wheel mounting module according to claim 4, further comprising a brake device including: a disc rotor that rotates with the wheel; and a brake caliper held by the housing of the wheel drive unit to stop rotation of the wheel by stopping rotation of the disc rotor.
